(19) United States
(12) Patent Application Publication
(10) Pub. No.: US 2025/0348088 A1
(43) Pub. Date: Nov. 13, 2025

(54) LOAD-BASED VERIFICATION OF ASSEMBLY

(71) Applicant: Oshkosh Corporation, Oshkosh, WI (US)

(72) Inventors: Devin Rosencrance, Oshkosh, WI (US); Patrick Dingman, Oshkosh, WI (US); Tyler Walsh, Oshkosh, WI (US); Guido Ritelli, Oshkosh, WI (US)

(73) Assignee: Oshkosh Corporation, Oshkosh, WI (US)

(21) Appl. No.: 19/086,792

(22) Filed: Mar. 21, 2025

Related U.S. Application Data
(60) Provisional application No. 63/643,788, filed on May 7, 2024.
(60) Provisional application No. 63/643,608, filed on May 7, 2024.
(60) Provisional application No. 63/643,653, filed on May 7, 2024.
(60) Provisional application No. 63/643,541, filed on May 7, 2024.
(60) Provisional application No. 63/643,723, filed on May 7, 2024.
(60) Provisional application No. 63/643,627, filed on May 7, 2024.
(60) Provisional application No. 63/643,617, filed on May 7, 2024.
(60) Provisional application No. 63/643,631, filed on May 7, 2024.
(60) Provisional application No. 63/643,528, filed on May 7, 2024.
(60) Provisional application No. 63/712,647, filed on Oct. 28, 2024.
(60) Provisional application No. 63/712,621, filed on Oct. 28, 2024.
(60) Provisional application No. 63/713,023, filed on Oct. 28, 2024.
(60) Provisional application No. 63/712,662, filed on Oct. 28, 2024.
(60) Provisional application No. 63/712,602, filed on Oct. 28, 2024.
(60) Provisional application No. 63/741,768, filed on Jan. 3, 2025.
(60) Provisional application No. 63/741,710, filed on Jan. 3, 2025.
(60) Provisional application No. 63/775,273, filed on Mar. 20, 2025.

(51) Int. Cl. G05D 1/656; B60P 7/13; G05D 107/70

(52) U.S. Cl. CPC G05D 1/656; B60P 7/13; G05D 2107/70

(57) ABSTRACT

A manufacturing system includes a vehicle configured to facilitate movement of a product throughout a manufacturing environment. The vehicle assembly includes a chassis, an interface coupled to the chassis and configured to support the product, and a sensor coupled to the interface. The sensor is operatively coupled to a controller, which is configured to receive sensor data, receive current stage of assembly of a product, determine an expected force based on the current stage of assembly, and compare the measured force and expected force. In response to a determination that the measured force differs from the expected force, the controller provides a notification to the user of the current status of the product.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (l) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

One exemplary embodiment relates to a manufacturing system. The manufacturing system includes a vehicle and a controller. The vehicle includes a chassis, an interface coupled to the chassis and configured to support at least a portion of a product, and a sensor coupled to the interface and configured to provide sensor data indicating a measured force on the interface. The controller is configured to receive sensor data provided by the sensor indicating the measured force, receive an indication of a current stage of assembly of the product, determine an expected force on the interface based on the current stage of assembly of the product, compare the measured force with the expected force, and in response to the determination that the measured force differs from the expected force, provide a notification to a user.

Another exemplary embodiment relates to a manufacturing system. The manufacturing system includes a vehicle and a controller. The vehicle includes a chassis, an interface coupled to the chassis and configured to support at least a portion of a product, and a sensor coupled to the interface and configured to provide sensor data indicating a measured force on the interface. The controller is configured to determine the measured force based on the sensor data, receive an indication of a current stage of assembly of the product, compare the measured force with the indication, and in response to the determination that the measured force differs from the indication, perform a control action.

Additionally, an exemplary embodiment relates to a method of manufacturing. The method may include providing a vehicle including an interface configured to support at least a portion of a product and a sensor coupled to the interface. The method may include inputting a product configuration and a current stage of assembly of the product into a controller. The method may include transferring, to the controller, the product configuration, and the current stage of assembly of the product. The method may include determining an expected force on the interface based on the current stage of assembly of the product. The method may include receiving sensor data, provided by the sensor, indicating a measured force of the product on the interface. The method may include comparing the measured force with the expected force. The method may include in response to a determination that the measured force differs from the expected force, performing a control action.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a block diagram of the vehicle of FIG. 1 supporting a product and equipped with sensors, according to an exemplary embodiment.

FIG. 10 is a block diagram of the vehicle of FIG. 1 and another vehicle equipped with sensors and cooperating to support a product, according to an exemplary embodiment.

FIG. 11 is a block diagram of a manufacturing method implemented in the production system of FIG. 8, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a manufacturing method includes a load-based verification of assembly of a product at each stage of production in a production system. The production system is configured to move a product through a manufacturing line to different stations using one or more vehicles. Each station may be associated with a different manufacturing or assembly process that is performed there. At each station, the build process may not be completed properly, which undesirably impacts the final product.

To counteract this a manufacturing system includes a parameter-based verification of assembly, such as load-based verification of assembly, at each stage of production to determine if assembly is completed properly. The manufacturing system includes one or more vehicles that move a product through the production line. Each vehicle includes a chassis. The chassis is coupled to one or more interfaces that support the product. The interface is coupled to a force sensor that detects the position and magnitude of mass of the product supported by that interface. The vehicle includes a controller, operatively coupled to the sensors, and trained to determine expected force sensor readings at each stage of assembly. At each station, the controller receives measured sensor readings of the current status of the product. The controller compares the measured sensor readings to the expected sensor readings. In response to the determination that measured sensor readings differ from expected sensor readings, the controller provides a notification to the user of potential reasons for the unacceptable load.

### Overall Vehicle

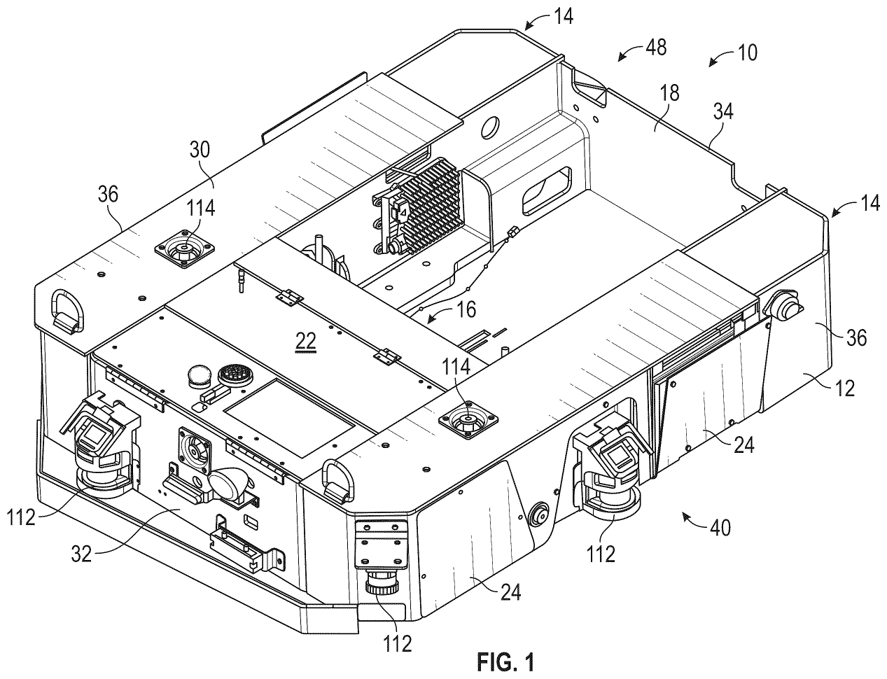

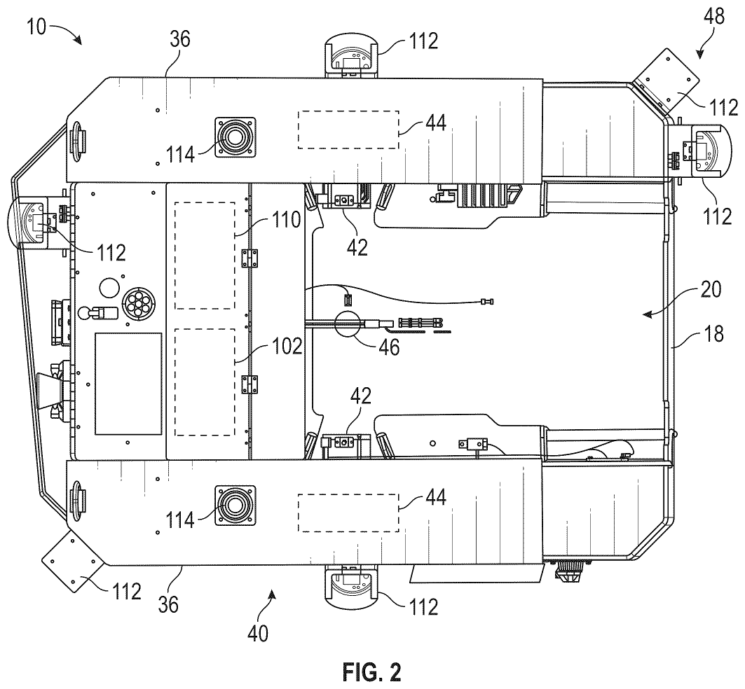

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

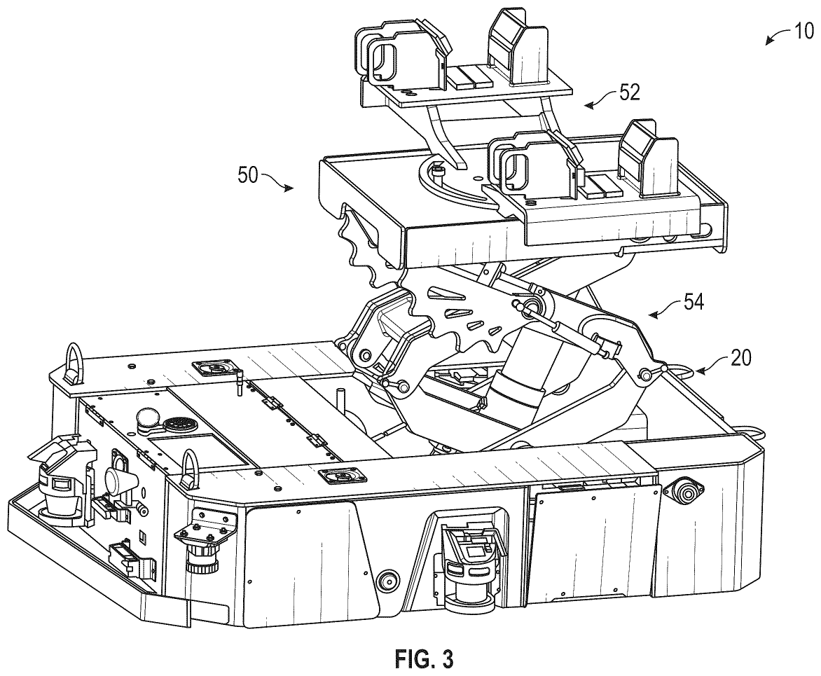

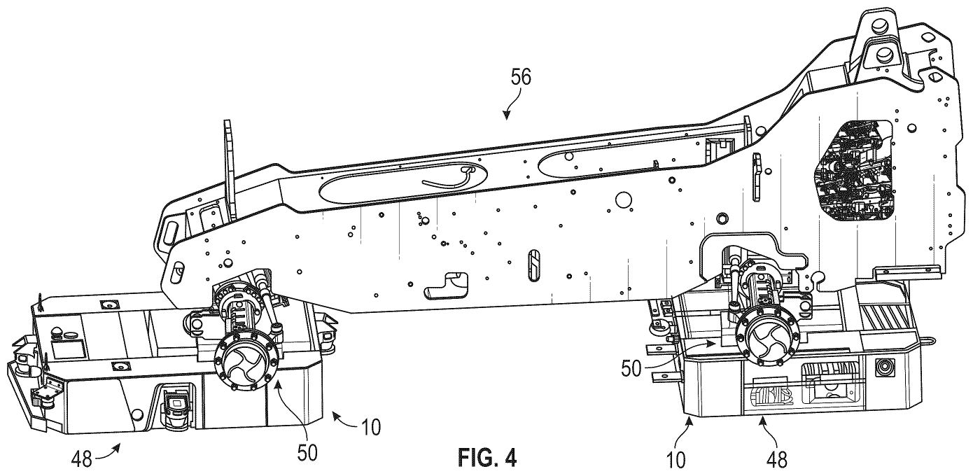

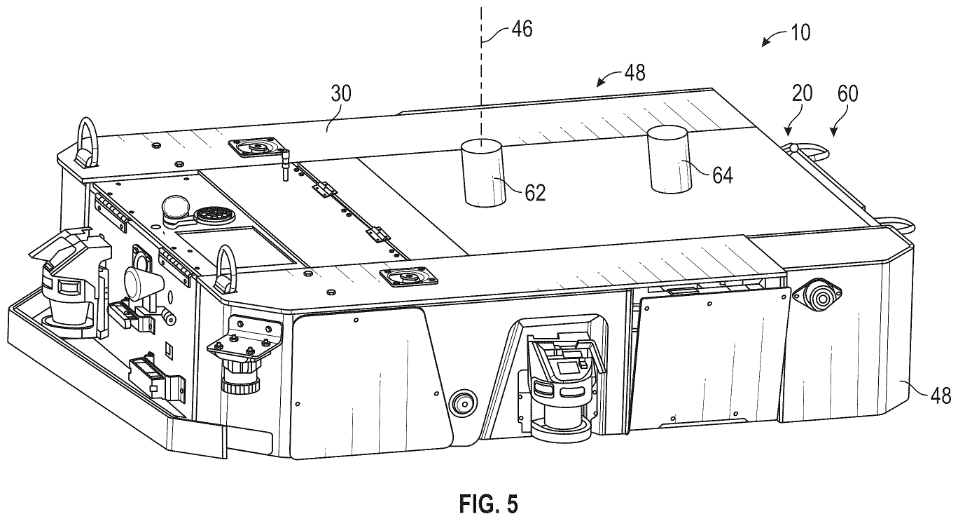

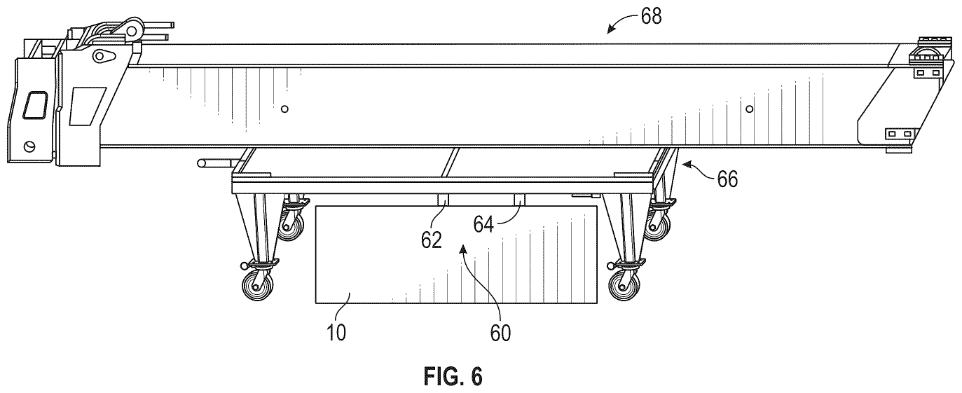

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

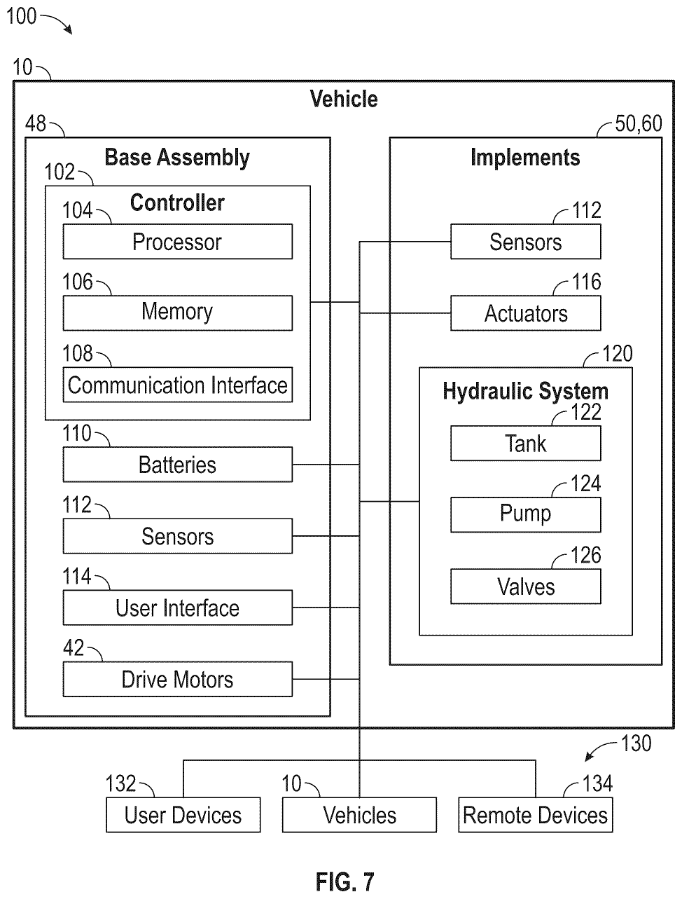

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the lifting implements 50 and cart implement 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

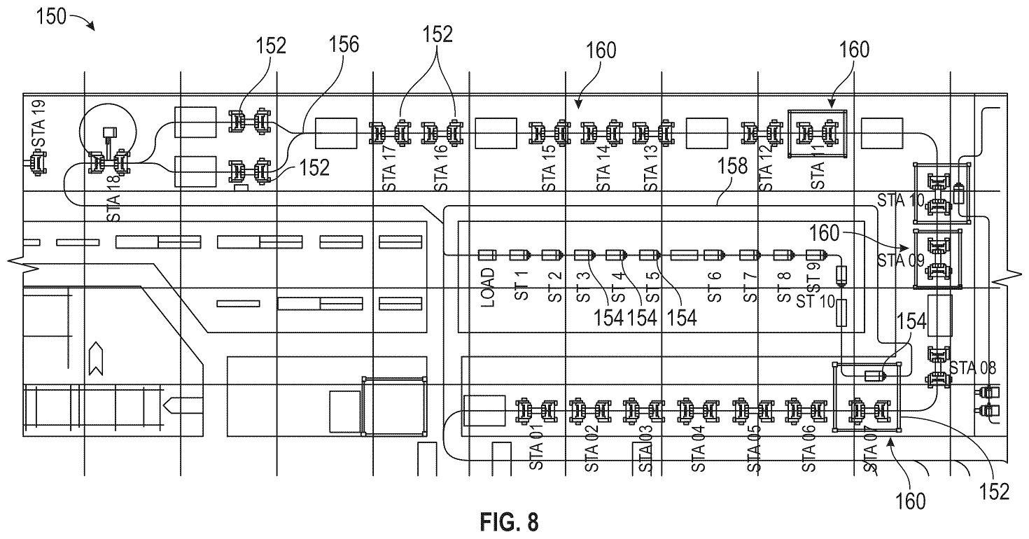

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Overall Manufacturing System

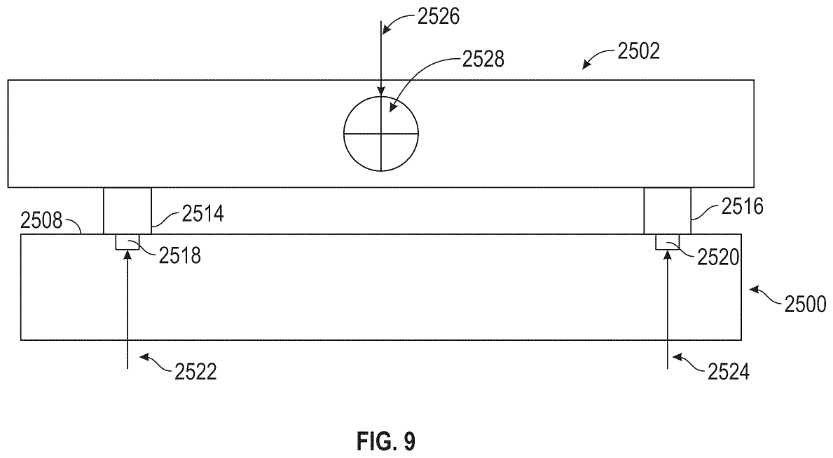

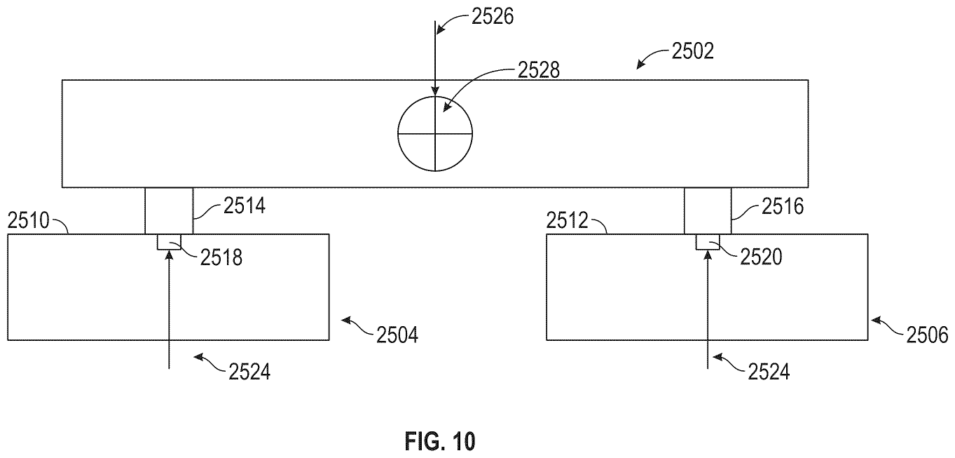

Referring to FIGS. 9 and 10, a manufacturing system includes a vehicle 2500. The vehicle 2500 may move a product 2502 (e.g., another vehicle 2500 or machine) along a manufacturing line as the product 2502 is assembled. In some embodiments, the manufacturing line is the production system 150, shown in FIG. 8. In some embodiments, the manufacturing system is configured to have a first vehicle 2504 and a second vehicle 2506 configured to move the product 2502 along the production line 150, as shown in FIG. 10. For example, certain large products, such as a telehandler, may be difficult to support with only a single vehicle 2500. To facilitate steering the product and spreading out the weight of the product the first vehicle 2504 and the second vehicle 2506 may be utilized.

In the example, shown in FIG. 10 a front end of the product 2502 is supported by the first vehicle 2504 and a back end of the product 2502 is supported by the second vehicle 2506. In some embodiments, the first vehicle 2504 and the second vehicle 2506 are independently operable. In other embodiments, operation of the first vehicle 2504 and/or the second vehicle 2506 is dependent on operation of the first vehicle 2504 and/or the second vehicle 2506. By way of example, the first vehicle 2504 may supply electrical energy to, propel, and/or control operation of the other vehicle. By way of example, the vehicle 2500, first vehicle 2504, and second vehicle 2506 may be the vehicle 10 shown in FIG. 1. By way of example, the product 2502 may be the telehandler 56 shown in FIG. 4.

The vehicle 2500 includes a chassis 2508. The chassis 2508 is configured to support other components of the vehicle 2500. In embodiments, which include a first vehicle 2504 and a second vehicle 2506, the first vehicle 2504 has a first chassis 2510 and the second vehicle has a second chassis 2512. By way of example, the chassis 2508, first chassis 2510, and second chassis 2512 may be the frame 12 shown in FIG. 1.

The vehicle 2500 includes a first interface 2514 and a second interface 2516. The first interface 2514 is configured to support a first portion of the product 2502. The second interface 2516 is configured to support a second portion of the product 2502. In some embodiments, a single interface (e.g., first interface 2514, second interface 2516) can be configured to support the entire product 2502. The first interface 2514 and the second interface 2516 are coupled to the chassis 2508. The first interface 2514 is coupled to a first portion (e.g., front end, etc.) of the chassis 2508 and the second interface 2516 is coupled to a second portion (e.g., back end, etc.), laterally separated from the first portion, of the chassis 2508. In embodiments which include a first vehicle 2504 and a second vehicle 2506, the first interface 2514 is coupled to the first chassis 2510 and the second interface 2516 is coupled to the second chassis 2512. In some embodiments, the first interface 2514 and the second interface 2516 may be interchangeable (e.g., cradle 52, lifting device, lift assembly 54, driving pin 62, turning pin 64, etc.). For example, the first interface 2514 can be changed from the cradle 52 to the lift assembly 54.

The vehicle 2500 includes a first sensor 2518. The first sensor 2518 is coupled to the first interface 2514. The first sensor 2518 can be configured to provide first sensor data indicating a first measured force 2522 (e.g., normal force, weight) on the first interface 2514. In some embodiments, the first sensor 2518 can be configured to provide first sensor data indicating a force of gravity 2526 on the product 2502. In embodiments with more than one vehicle 2500, the first sensor 2518 is coupled to the first interface 2514 on the first vehicle 2504. In some embodiments, the first sensor 2518 is a force sensor (e.g., load cell, inertial measurement unit, etc.). In some embodiments, the first sensor 2518 is at least one of a current sensor, a voltage sensor, or a pressure sensor, which infer the force of the product 2502 based on a sensed value (e.g., a load on an electrical actuator, a load on a drive motor, a hydraulic pressure, etc.).

In some embodiments the first measured force 2522 can be the normal force on the first interface 2514. Additionally or alternatively, the first measured force 2522 can be the weight of the product 2502 on the first interface 2514. In such embodiments, the first sensor 2518 may communicate with other components of the manufacturing system (e.g., a controller 102, etc.) to calculate a center of gravity 2528 of the product 2502.

The vehicle 2500 includes a second sensor 2520. The second sensor 2520 is coupled to the second interface 2516. The second sensor 2520 can be configured to provide second sensor data indicating a second measured force 2524 (e.g., normal force, weight) on the second interface 2516. In some embodiments, the second sensor 2520 can be configured to provide second sensor data indicating the force of gravity 2526 on the product 2502. In embodiments with more than one vehicle 2500, the second sensor 2520 is coupled to the second interface 2516 on the second vehicle 2506. In some embodiments, the second sensor 2520 is a force sensor (e.g., load cell, inertial measurement unit, etc.). In some embodiments, the second sensor 2520 is at least one of a current sensor, a voltage sensor, or a pressure sensor, which infer the force of the product 2502 based on a sensed value (e.g., a load on an electrical actuator, a load on a drive motor, a hydraulic pressure, etc.).

In some embodiments the second measured force 2524 can be the normal force on the second interface 2516. Additionally or alternatively, the second measured force 2524 can be the weight of the product 2502 on the second interface 2516. In such embodiments, the second sensor 2520 may communicate with other components of the manufacturing system (e.g., a controller 102, etc.) to calculate the center of gravity 2528 of the product 2502.

The manufacturing system further includes a controller 102. The controller 102 is operatively coupled to the first sensor 2518 and the second sensor 2520. The controller 102 is configured to move the product 2502 from one stage of assembly to another stage of assembly (e.g., from one station 160 to another station 160). The controller 102 is configured to receive sensor data from the first sensor 2518 and the second sensor 2520 indicating a first measured force 2522 on the first interface 2514 and a second measured force 2524 on the second interface 2516. By way of example, the controller 102 may be part of the control system 100 and may include a processor 104, a memory 106, and a communication interface 108 as shown in FIG. 7.

The controller 102 is configured to receive an indication of a current stage of assembly of the product 2502 (e.g., components that need to be added, etc.). The controller can be configured to determine an expected force (e.g., first expected force on the first interface 2514, second expected force on the second interface 2516) based on the current stage of assembly of the product 2502. In some embodiments, the indication includes the expected force for a stage of the manufacturing process. In some embodiments, the memory 106 may store first expected force data and second expected force data. In such embodiments, first expected force data is the expected force (e.g., expected normal force, expected force of gravity, etc.) of the product 2502 on the first interface 2514 and second expected force data is the expected force (e.g., expected normal force, expected force of gravity, etc.) of the product 2502 on the second interface 2516.

In some embodiments, the memory 106 may contain one or more instructions (e.g., comparative analysis, center of gravity calculations, etc.), that when executed by the processor 104, may cause the processor 104 to perform various functions (e.g., compare expected and measured values, calculate center of gravity 2528, etc.). After receiving the indication of the current stage of assembly of the product 2502, the controller 102 is configured to compare the measured force (e.g., first measured force 2522, second measured force 2524) with the expected force (first expected force, second expected force) using the instructions.

The controller 102 can be configured to perform one or more control actions in response to a difference between expected force data and measured force data (e.g., first measured force 2522 differs from first expected force, second measured force 2524 differs from second expected force, etc.). The control actions can be at least one of notifying a user, controlling an operating parameter (e.g., speed, direction of travel, acceleration of the vehicle 2500, etc.) of the vehicle 2500, the first vehicle 2504, and/or the second vehicle, controlling the operation of another vehicle 2500, controlling the operation of the production line 150, etc.

The controller 102 can further be configured to determine if the station 160 is complete (e.g., all components are properly installed on the product 2502, etc.) or if an error has occurred (e.g., components are not properly installed, a tool is left on the product 2502, etc.). For example, the controller 102 can be configured to receive first sensor 2518 and second sensor 2520 data indicating a first measured force 2522 and a second measured force 2524, respectively. In such example, the controller 102 can compare the measured force data (e.g., first measured force 2522, second measured force 2524) to the expected force data (e.g., first expected force, second expected force, etc.) to determine if there is a difference between the expected force data and the measured force data. In response to a difference between expected force data and measured force data the controller 102 can be configured to determine that the station 160 is incomplete or an error has occurred.

The first expected force data and the second expected force data can be for a number of parameters (e.g., weight, center of gravity, time at station, etc.) and can be a range of acceptable values. Ranges of acceptable values can be provided for each station 160, and may vary from station 160 to station 160.

The controller 102 can be configured to calculate a center of gravity 2528 of the product 2502. For example, the controller 102 can be configured to perform center of gravity calculations using the first measured force 2522 (e.g., weight of the product 2502 on the first interface 2514) and the second measured force 2524 (e.g., weight of the product 2502 on the second interface 2516). The center of gravity 2528 can be configured to be a range of acceptable positions along the product 2502. If the measured center of gravity 2528 falls outside the range of acceptable center of gravity positions, the controller 102 can be configured to determine the station 160 is incomplete or an error has occurred. In response to the determination that the station 160 is incomplete, the controller 102 can perform a control action. The control action can include providing a notification to the user and/or adjusting an operating parameter of the vehicle 2500. The operating parameter is at least one of a speed, a direction of travel, or an acceleration of the vehicle 2500. In some embodiments, a station 160 is incomplete when a component is not installed on the product 2502. In some embodiments, an error has occurred when a component is installed incorrectly or in the wrong position on the product 2502, additional items (e.g., tools, other product components, etc.) are left on the product 2502, and/or a failed first sensor 2518 and/or second sensor 2520 reading.

In response to an error and/or an incomplete assembly the controller 102 can notify the user of the status of the product 2502. The notification can be visual or aural. For example, the notification may be a flashing light, or an alarm. In some embodiments, the notification includes a prediction of the cause of the error. For example, one or more parameters of the notification can be based on the outcome of the comparison between the measured value and the expected range of values for that specific parameter (e.g., weight, center of gravity 2528, etc.), and one or more other sensed values such as time at station 160. For example, in response to the comparison indicating the measured weight falls below an expected weight range and/or the time at station 160 being less than an expected time at station 160, the controller 102 can notify a user with an alarm that indicates, either through tone, color, spoken language, etc., that the product 2502 may not include the component as expected in that specific station 160. Similarly, if the measured weight falls above the expected weight, the notification may indicate that a tool was left on the vehicle 2500. In this way, the controller 102 can both detect the issue and attempt to predict the source of the issue based on the values of the measured weight and how it compares to the expected value range.

In some embodiments, the controller 102 may also control the vehicle 10, such as the controller 102 may prohibit further movement of the vehicle 10 from one station 160 to another until the measured value (e.g., weight, center of gravity) falls within the acceptable range. In some embodiments, the controller 102 may automatically control the vehicle 2500 to move out of the main product line 150, for example to a staging or waiting area, to allow the production line 150 to continue and to allow for a safe space for a user to troubleshoot the problem. Beneficially, this can allow the production line 150 to continue to run while a problem at a single station 160 is resolved. In some embodiments, in response to an input from a user, the vehicle 2500 can ignore a condition such as a measured value exceeding a range. For example, a user may input an override request and control the vehicle 2500 to the next station 160 despite, according to the vehicle sensors (e.g., the first sensor 2518, the second sensor 2520), the measured value is outside of the expected value.

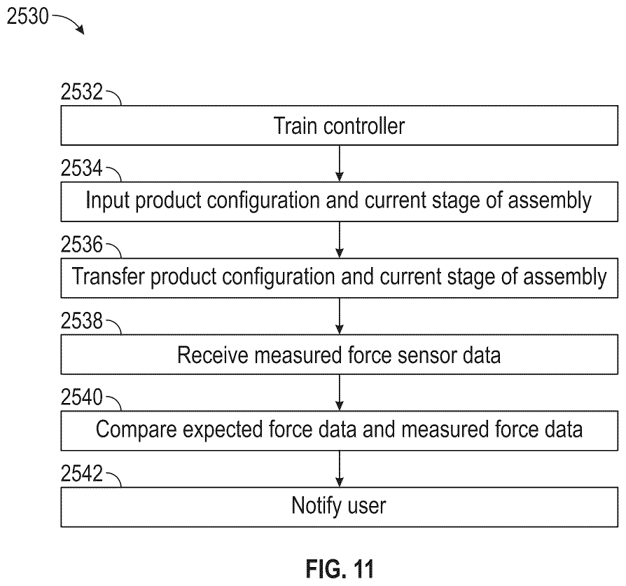

Referring to FIG. 11 a manufacturing method 2030 is shown according to exemplary embodiment. The manufacturing method 2530 is used for determining the status of the product 2502 build process at each station 160 of the production system 150 for each individual product configuration. By way of example, the production system 150 and individual stations 160 may be the production system 150 and stations 160 shown in FIG. 8.

Referring to FIG. 11, the manufacturing method 2530 includes a training step 2532. The training step 2532 includes simulating a production line 150 for each product configuration and storing expected force data. At each station of the production line 150, first sensor data indicating a first force on a first interface 2514 on a first vehicle 2504 and—if a second vehicle 2506 is also being used—second sensor data indicating a second force on a second interface 2516 may be collected and stored in the memory 106. The process of collecting first sensor data and second sensor data is repeated an n number (e.g., n=3, n=5, n=7, etc.) of times and the values are stored in the memory 106 as a range of values for a first expected force on the first interface 2514 and a second expected force on the second interface 2516. By way of example, the training step 2532 may include simulating the production system 150, shown in FIG. 8. In some embodiments, the expected weight of each component added to the product 2502 at each station 160 is stored in the memory 106 of the controller 102 and further used for predictive analysis (i.e. required components not installed, component installed in the wrong location, additional items accidentally left on vehicle 2500, etc.) of the status of production.

In some embodiments, step 2532 is optional and the controller 102 is provided (e.g., by the user, etc.) the expected weight, first expected force, and/or second expected force for one or more stations 160 prior to the start of manufacturing. For example, the expected weight can be based on measured values from prior operation of the production line 150. In some embodiments, the station 160 specific data provided to the first vehicle 2504 and/or the second vehicle 2506 may include an acceptable weight or weight range and acceptable center of gravity position ranges for each station 160 of a production line 150. If a weight is outside of the acceptable weight range, then the station 160 is either incomplete or a mistake has occurred. If a weight is within the acceptable range, the first vehicle 2504 and/or the second vehicle 2506 can proceed to the next stage. Similarly, if a center of gravity 2528 is outside the acceptable range of center of gravity positions, the station 160 may be incomplete or a mistake may have occurred. If the center of gravity 2528 is within the acceptable range, then the first vehicle 2504 and/or the second vehicle 2506 can proceed to the next station 160.

The manufacturing method 2530 includes an input step 2534. The input step 2534 may include the user inputting the desired product configuration and desired current stage of assembly of the product 2502 into the controller 102. By way of example, the controller 102 may be the controller 102 shown in FIG. 7. In some embodiments, the user may input the product configuration into a user device 132 of the controller 102 (e.g. smartphones, tablets, laptops, desktop computers, etc.). Additionally or alternatively, a user may input the product configuration into a user interface 114 of the controller 102 (i.e. input device that receives information and may include buttons, switches, knobs, touch screens, microphones, other input devices, etc.). Additionally or alternatively, the user may input the product configuration into a remote device 134 of the controller 102 (i.e. servers).

In some embodiments, one or more stations 160 of the production line 150 may include an indicator (e.g., visual indicator, aural indication, transmitter, etc.) which provides an indication of the current product configuration and/or current stage of the first vehicle 2504 and/or the second vehicle 2506. For example, each station 160 can include a Bluetooth emitter configured to emit, within a predetermined area of the production line 150, a first signal indicating that the area is identified as one of the stations 160. At another different station 160, a different Bluetooth emitter may emit a second signal, different than the first signal, indicating the identity of the other station 160. This emitter can be Bluetooth, WiFi, NFC, etc.

In some embodiments, the indicator is a visual indicator that is recognized by one sensor 112 (e.g., cameras) of the first vehicle 2504 and the second vehicle 2506. In some embodiments, the indicator is a specific sound or tone which can be sensed by the sensors 112 of the first vehicle 2504 and the second vehicle 2506. In some embodiments, the indicator is a magnetic indicator that can be sensed by magnetic sensors 112 such as a Hall-effect sensors, wherein the magnetic field of each magnetic indicator is unique and identifiable, to be associated with a station 160. In some embodiments, the vehicle 10 can identify the current product configuration and/or station 160 entirely based on image processing techniques.

The manufacturing method 2530 includes a transfer step 2536. The transfer step 2536 includes transferring to the controller 102, the product configuration and desired current stage of assembly of the product 2502. In other embodiments, step 2536 includes the vehicle 2500 itself determining the product configuration and the desired current state of assembly of the product 2502 as discussed above. When the controller 102 receives and/or determines the product configuration and the desired current stage of assembly of the product 2502, the controller 102 may determine or retrieve from memory 106 the corresponding first expected force, second expected force, expected weight of each component, and the expected force of gravity 2526 at the desired station 160. Each of the first expected force, second expected force, expected weight of each component, and the expected force of gravity 2526 at the desired station 160 may be a range of acceptable values.

In some embodiments, the user device 132, user interface 114, or remote device 134 may facilitate wireless communication (e.g. through Bluetooth, Wi-Fi, radio transmission, inductive transmission of energy, etc.) to the controller 102 to transfer the product configuration and the desired current stage of assembly of the product 2502. Additionally or alternatively, the user device 132, user interface 114, or remote device 134 may facilitate wired communication (e.g. through CAN, Ethernet, communication of power, etc.) to the controller 102 to transfer the product configuration and the desired current stage of assembly of the product 2502.

The manufacturing method 2530 includes a receiving sensor data information step 2538. The receiving sensor data information step 2538 includes providing by the first sensor 2518, first sensor 2518 data indicating a first measured force 2522 on the first interface 2514 (i.e. normal force on the first interface 2514) to the controller 102 and providing by the second sensor 2520, second sensor 2520 data indicating a second measured force 2524 on the second interface 2516 (i.e. normal force on the second interface 2516) to the controller 102. In some embodiments, the receiving sensor data information step 2538 includes providing, by the first sensor 2518 and the second sensor 2520, measured force data indicating the measured force of gravity 2526 on the product 2502 and the position of the center of gravity of the product 2502.

The manufacturing method 2530 includes a comparative step 2540. The comparative step 2540 includes comparing measured force data to expected force data (e.g., first measured force data to first expected force data, second measured force data to second expected force data) and determining if the measured force data, found in the receiving sensor data information step 2538, is within the range of expected sensor data, found in the training step 2532. In some embodiments, the processor 104 compares first expected force data to first measured force 2522 data and compares second expected force data to second measured force 2524 data to determine if the measured force data differs from expected force data. Additionally, in some embodiments, the processor 104 performs a center of gravity calculation to determine the measured center of gravity 2528 of the product 2502 and compares the expected center of gravity 2528 to the measured center of gravity 2528 to determine if measured center of gravity 2528 differs from expected center of gravity 2528.

The manufacturing method 2530 includes a notify user step 2542. The notify user step 2542 includes notifying the user when the measured force data differs from the expected force data described in the comparative step 2540. If the measured force data does not differ from the expected force data a positive notification (i.e. check mark, green screen, etc.) will be used to notify the user. If the measured force data differs from the expected force data a negative notification (e.g., an X, a red screen, etc.) will be used to notify the user. In some embodiments, following the transfer of the status of the product from the controller 102 to the user device 132, the controller will provide a notification to the user describing the status of the product 2502 (e.g., the measured sensor data is outside the range of the expected sensor data). Additionally or alternatively, the controller 102 can transfer the status of the product to the user interface 114, providing a notification to the user about the status of the product 2502. Additionally or alternatively, the controller 102 can transfer the status of the product to the remote device 134, providing a notification to the user about the status of the product 2502.

In some embodiments, the notification will include predictive analysis (i.e. required components not installed, component installed in the wrong location, additional items accidentally left on vehicle 2500, etc.). In some embodiments, the notification will provide a check list of required components at each station 160. In some embodiments, the controller 102 may also perform one or more other control actions such as controlling a state or position of the vehicle (e.g., vehicle 10, first vehicle 2504, second vehicle 2506) such as inhibiting further movement or automatically moving the vehicle out of the production line, controlling the state or position of vehicles in adjacent stations 160 of the production line 150, controlling the production line 150 itself (e.g., slowing the line, speeding up the line, etc.) or other control actions to facilitate the efficient operation of the production line 150.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein. For example, the first sensor 2518 of the exemplary embodiment shown in at least FIG. 9 may be incorporated in the vehicle 10 of the exemplary embodiment shown in at least FIG. 1. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A manufacturing system, comprising:
a vehicle, comprising:
a chassis;
an interface coupled to the chassis and configured to support at least a portion of a product; and
a sensor coupled to the interface and configured to provide sensor data indicating a measured force on the interface; and
a controller configured to:
receive sensor data provided by the sensor indicating the measured force;
receive an indication of a current stage of assembly of the product;
determine an expected force on the interface based on the current stage of assembly of the product;
compare the measured force with the expected force; and
in response to a determination that the measured force differs from the expected force, provide a notification to a user.

2. The manufacturing system of claim 1, wherein the interface is a first interface, the sensor is a first sensor, the sensor data is first sensor data, and the measured force is a first measured force, wherein the vehicle further comprises:
a second interface coupled to the chassis and configured to support a second portion of the product; and
a second sensor coupled to the second interface and configured to provide second sensor data indicating a second measured force on the second interface.

3. The manufacturing system of claim 1, wherein the vehicle is a first vehicle, the chassis is a first chassis, the interface is a first interface, the sensor is a first sensor, the sensor data is first sensor data, and the measured force is a first measured force, further comprising a second vehicle comprising:
a second chassis;
a second interface coupled to the second chassis and configured to support a second portion of the product; and
a second sensor coupled to the second interface and configured to provide second sensor data indicating a second measured force on the second interface.

4. The manufacturing system of claim 3, wherein:
the first measured force is at least one of a normal force of the product on the first interface or a weight of the product on the first interface; and
the second measured force is at least one of a normal force of the product on the second interface or a weight of the product on the second interface.

5. The manufacturing system of claim 1, wherein the controller is further configured to:
determine a measured center of gravity of the product using the measured force;
determine an expected center of gravity of the product based on the current stage of assembly of the product;
compare the measured center of gravity with the expected center of gravity; and
in response to a determination that the measured center of gravity differs from the expected center of gravity, provide a notification to the user.

6. The manufacturing system of claim 1, wherein the vehicle is configured to move the product from a current station to a next station.

7. The manufacturing system of claim 1, wherein:
the notification comprises a prediction identifying a source of the difference between the measured force and the expected force; and
the source is at least one of the product is missing an expected component, the product has an additional component that should be absent from the product, or the product has a component installed in a wrong location.

8. The manufacturing system of claim 1, wherein, in response to the determination that the measured force differs from the expected force, the controller is further configured to:
limit movement of the vehicle from a current station to a next station; or
operating the vehicle to transport out of the manufacturing system.

9. A manufacturing system, comprising:
a vehicle, comprising:
a chassis;
an interface coupled to the chassis and configured to support at least a portion of a product; and
a sensor coupled to the interface and configured to measure a force on the interface; and
a controller configured to:
obtain an expected force for the interface indicating a current stage of assembly of the product;
compare the force on the interface with the expected force; and
in response to a determination that the force on the interface differs from the expected force, perform a control action.

10. The manufacturing system of claim 9, wherein the vehicle is configured to move the product from a current station to a next station.

11. The manufacturing system of claim 9, wherein the control action comprises at least one of providing a notification to a user or adjusting an operating parameter of the vehicle.

12. The manufacturing system of claim 11, wherein the operating parameter comprises at least one of a speed, a direction of travel, or an acceleration of the vehicle.

13. The manufacturing system of claim 9, wherein the sensor is at least one of a force sensor, a current sensor, a voltage sensor, or a pressure sensor configured to provide an indication of a force of the product at the interface, the controller configured to use the indication to determine the force on the interface.

14. The manufacturing system of claim 9, wherein the vehicle is a first vehicle, the chassis is a first chassis, the interface is a first interface, the sensor is a first sensor, the sensor data is first sensor data, and the measured force is a first measured force, further comprising a second vehicle comprising:
a second chassis;
a second interface coupled to the second chassis and configured to support a second portion of the product; and
a second sensor coupled to the second interface and configured to provide second sensor data indicating a second force on the second interface.

15. A method of manufacturing, the method comprising:
providing a vehicle including (i) an interface configured to support at least a portion of a product, and (ii) a sensor coupled to the interface;
obtaining a product configuration and a current stage of assembly of the product;
determining an expected force on the interface based on the current stage of assembly of the product;
receiving sensor data, provided by the sensor, indicating a measured force of the product on the interface;
comparing the measured force with the expected force; and
in response to a determination that the measured force differs from the expected force, performing a control action.

16. The method of claim 15, further comprising:
training a controller by:
simulating a production line for each product configuration;
receiving sensor data indicating the expected force at each stage of production; and
storing, in a memory of the controller, a range of the expected force at each stage of production.

17. The method of claim 15, wherein performing the control action comprises:
providing a notification to a user of a status of the product; or
adjusting an operating parameter of the vehicle.

18. The method of claim 17, wherein providing the notification comprises:
predicting a source of the difference between the measured force and the expected force, wherein the source comprises at least one of the product is missing an expected component, the product has an additional component that should be absent from the product, or the product has a component installed in a wrong location.

19. The method of claim 17, wherein the operating parameter comprises at least one of a speed, a direction of travel, or an acceleration of the vehicle.

20. The method of claim 15, in response to a determination that the measured force differs from the expected force, the method further comprises:
limiting movement of the vehicle from a current station to a next station; or
operating the vehicle to transport out of a production line.
